(19) United States
(12) Patent Application Publication
(10) Pub. No.: US 2012/0085170 A1
(43) Pub. Date: Apr. 12, 2012

(54) Shock Resistant Mounting for High G Shock Accelerometer

(76) Inventor: James C. Letterneau, Ladera Ranch, CA (US)

(21) Appl. No.: 12/900,075

(22) Filed: Oct. 7, 2010

(51) Int. Cl. G01P 15/12

(52) U.S. Cl. 73/514.33

(57) ABSTRACT

A high-g shock accelerometer is provided with an LCC case. A MEMs acceleration sensor is positioned in an interior of the LCC case. The MEMs acceleration sensor has exterior surfaces including top and bottom surfaces and side surfaces. An elastomer is in an adjacent relationship or in contact to a majority of the exterior surfaces and to the interior of the LCC case. The MEMs acceleration sensor with the elastomer attenuates LCC case strain sensitivity while retaining wide band frequency response.

### BACKGROUND

1. Field of the Invention

The present invention relates generally to high G shock accelerometers, and more particularly to a MEMs acceleration sensor in a Leadless Chip Carrier (LCC) that can withstand high G shock.

2. Description of the Related Art

For many years, integrated circuits have been housed in dual-in-line packages (DIPs). A DIP has parallel rows of leads which extend from opposite sides of a body that houses an integrated circuit chip. The body of the DIP usually is rectangular and typically from 14 to 64 leads are spaced along the longer sides of the body on 0.100 inch (2.54 mm) centers. The DIP ordinarily is installed on a printed circuit board by soldering the leads to the circuit board or by inserting the leads into a DIP socket which has been soldered to the circuit.

More recently, integrated circuit packages have been developed wherein leads are provided along four sides of a body that houses an integrated circuit chip or chips. Typically, the body or housing containing the integrated circuit is square and an equal number of leads are arranged along each side of the body. These integrated circuit devices are referred to as LCCs for leadless chip carriers. The leads usually are more closely spaced than the leads in a DIP device, and this coupled with the leads being located along all four sides of the LCC in part enables more denser packing of integrated circuits on printed circuit boards. Like a DIP, an LCC may be installed on a printed circuit board by hand soldering the leads thereof to the circuit board. However, the LCC ordinarily is surface mounted on the printed circuit board.

State-of-the-art LCCs, such as those known as quad flat pack carriers, or more simply quad packs, may have a large number of leads, such as 132 leads with 33 leads per side of the carrier body. The leads of these quad packs typically are quite delicate and are easily damaged and more easily displaced.

As with DIPs, it is desirable to have an electrical connector such as a test probe for making temporary electrical connections with each of the leads of an LCC for testing while the LCC is in place on a printed circuit board. Since the LCC has leads located along each of the four sides of the LCC body, test probes for DIPs cannot be used since they connect with leads on only two opposed sides of an integrated circuit package. Likewise, various fixtures or mounts provided for DIPs cannot be used with LCCs. In an effort to satisfy the need for a test probe for an LCC, a few electrical connector devices have been developed.

Examples of these electrical connector devices are shown in the following U.S. patents: U.S. Pat. No. 4,541,676 to Hansen et al, U.S. Pat. No. 4,556,269 to Anderson et al, U.S. Pat. No. 4,671,590 to Ignaziak and U.S. Pat. No. 4,671,592 to Ignaziak, all fully incorporated herein by reference.

These devices, in general, apply pressure to surface mounted leads of an LCC in a direction parallel to the printed circuit board. This does not present a problem with LCCs including J-shape, surface mount leads. However, a problem may arise if used with a quad pack surface mounted to a printed circuit board, because the thin and fragile leads of the quad pack may not be able to withstand the pressure applied by the four-sided devices disclosed in these patents.

Shock accelerometers are employed in such wide-ranging fields of industrial measurement as collision tests conducted on structures, drop impact tests, stress analysis tests and vibration analysis tests.

In any dynamic system, of which the accelerometer is only one example, the system delay increases as the time wise variation in the input signal becomes faster, causing a phase lag between the input signal and the output signal. Therefore, similarly to the case of the gain, the frequency at which the phase lag comes to exceed the tolerable limit is defined as the upper limit frequency for the phase.

Elastic waves and plastic waves are generated in the interior of an object to which an accelerometer is attached when the object is subjected to an impact. In the measurement of shock acceleration for evaluation of breaking, the acceleration output signal is sometimes passed through an electrical filter for removing the effect of the elastic waves. Where the phase of the filter output signal has to be taken into consideration, it is indispensable to have prior knowledge of the relationship between the phase lag and the frequency of the accelerometer output signal itself, that is to say, of the phase characteristics. Also, in cases where the signal output by the accelerometer is to be used as a trigger signal and the timing thereof is subject to severe conditions, it becomes impossible to use phase compensation and other such control techniques unless the phase characteristics are known.

There is a need for an improved MEMs acceleration sensor. There is a further need for securing a MEMs acceleration sensor in a LCC that can withstand high G shock.

### SUMMARY

An object of the present invention is to provide an improved MEMs acceleration sensor.

Another object of the present invention is to provide a MEMs acceleration sensor in an LCC package or case that can withstand high G shock.

A further object of the present invention is to provide a MEMs acceleration sensor in an LCC package or case that has low case strain sensitivity to low levels while maintaining good high frequency response.

These and other objects of the present invention are achieved in a high-G shock accelerometer that has an LCC case. A MEMs acceleration sensor is positioned in an interior of the LCC case. The MEMs acceleration sensor has exterior surfaces including top and bottom surfaces and side surfaces. An elastomer is in an adjacent relationship or in contact to a majority of the exterior surfaces and to the interior of the LCC case.

### DESCRIPTION OF THE DRAWINGS

FIG. 1 illustrates a high-G shock acceleration sensor in an LCC package in one embodiment of the present invention.

FIG. 2 illustrates the FIG. 1 sensor with additional elements of the sensor in one embodiment of the present invention.

FIG. 3 illustrates the FIG. 1 sensor with an elastomer in one embodiment of the present invention.

### DETAILED DESCRIPTION

The present invention provides a mounting or suspension that is applicable to inertial devices, including but not limited to, linear accelerometers, angular accelerometers, rate gyroscopes and the like. With the present invention, in one embodiment of a MEMs acceleration sensor with an elastomer an attenuation of LCC case strain sensitivity is achieved simultaneously with high fidelity transmission of both low and high frequency acceleration inputs.

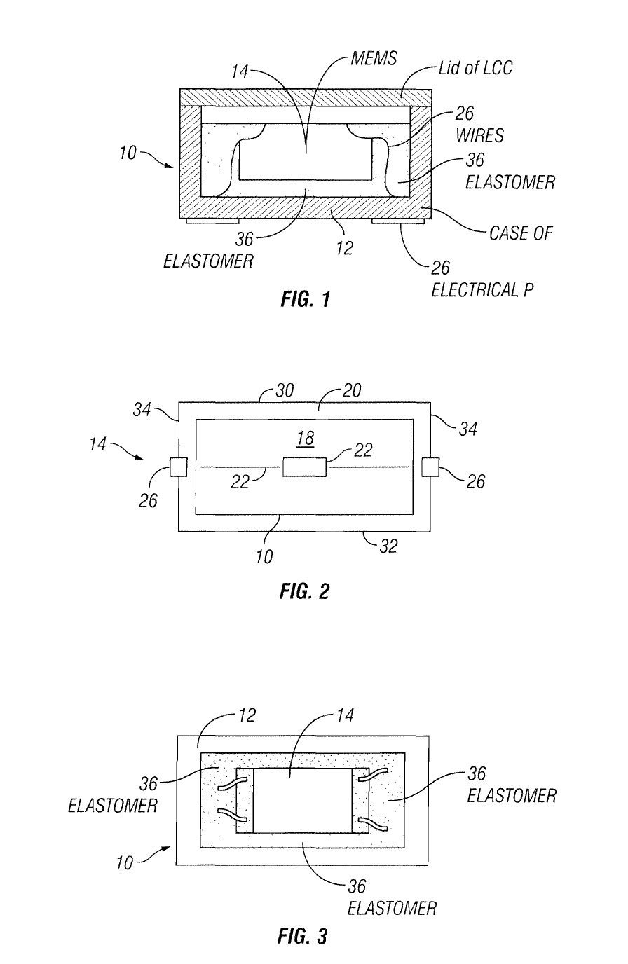

As illustrated in FIG. 1, one embodiment of the present invention is a high G-shock accelerometer 10 with an LCC case 12. A MEMs acceleration sensor 14 is positioned in an interior of the LCC case 12.

As shown in FIG. 2, the MEMs acceleration sensor 14 (die) has a base 16, a core 18 and a lid 20. A seismic mass 22 is positioned in the core 18. A plurality of piezoresistive strain gages 24, electrical traces 26 and bonding pads 28 are included. The MEMs acceleration sensor 14 has exterior surfaces including top and bottom surfaces and 30 and 32 side surfaces 34. One embodiment of a suitable MEMs acceleration sensor 14 is disclosed in U.S. Pat. No. 4,999,735, fully incorporated herein by reference. The LCC 10 can be used for SMT mounting, hand soldered, and the like.

As shown in FIG. 3, an elastomer 36 is positioned between a majority of the exterior surfaces of the MEMs acceleration sensor 14 and an interior 38 of the LCC case 12. The elastomer can provide an encapsulation and attach the MEMs acceleration sensor 14 to the bottom, both ends and both sides of the LCC housing, or it can be in an adjacent relationship to all or a portion of the MEMs acceleration sensor 14.

A variety of different elastomers 36 can be used, including but not limited to, RTV (room temperature vulcanizing) rubber, nitrile (Buna N) rubber, silicone rubber, fluorosilicone rubber, polysulfide rubber, natural rubber, polybutadiene, neoprene, fluoroelastomers, perfluoroelastomers and the like. In one embodiment, the elastomer used is an excellent adhesive, and the bottom surface, both ends and both sides of the LCC case 12 provide the surface area necessary to retain the MEMS acceleration sensor 14 in the LCC case 12 under high G shocks. In various embodiments, the G shocks can range from 100 G to more than 300,000 G. In one embodiment, the G shock is at least 50,000 G. In another embodiment, the G shock is at least 80,000 G.

The MEMS acceleration sensor die 14 is coupled to a bottom of the LCC case 12 via the elastomer 36. Over temperature, the expansion of the LCC case 12 is different than the expansion of the MEMS acceleration die 14. Because the elastomer 36 (which can be, as a non-limiting example, approximately 30 Shore A durometer) readily stretches (elongates). The stress generated due to the differential expansion of the two different materials is largely dissipated by the elongation of the elastomer 36. The same is true if shear or tensile stresses are applied to the LCC case 12. The flexibility of the elastomer 36 isolates the MEMS acceleration die 14 from being stressed. Stressing of the MEMS acceleration 14 can result in large shifts in the residual zero, and smaller shifts in the sensitivity (or span) of the unit.

In one embodiment, the elastomer 36 is a low durometer elastomer. With the elastomer, strains in the case are not readily transmitted into the MEMs acceleration sensor 14. Due to the incompressibility of the elastomer, transmission of both low and high frequency inputs is excellent.

As a non-limiting example, a low durometer elastomer has very large elongation. In one embodiment, a 200% to about a 300% elongation of the elastomer 36 coupled to the LCC case 12 attenuates stresses transmitted into the MEMs acceleration sensor 14.

The elastomer 36 can be applied by a number of different methods including but not limited to, adhesive bonding and the like, which will usually be to a PCB.

The presence of the elastomer 36 between the MEMs acceleration sensor 14 and the LCC case 12 has negligible effect on phase and amplitude frequency response. By negligible, it is meant that there is minimum effect on the performance of the MEMs acceleration sensor.

In one embodiment, more than 75% of the exterior surfaces of the MEMs acceleration sensor 14 are in contact with the elastomer 36. In one embodiment, the bottom surface 32 and the side surfaces 34 are in contact with the elastomer 36. In another embodiment, the bottom surface 32, side surfaces 34 and a portion of the top surface 30 are in contact with the elastomer 36.

In one specific embodiment, the LCC 10 can be a MEMS tri-stack sensor in a LCC case 12 that can withstand shocks of at least 180,000 G. The present invention does not adjust the case strain output. However, the case strain output can be measured. In one embodiment, the measurement was made at 250 microstrain, i.e. a 250 microstrain was applied to the bottom of the LCC case 12 and the change in acceleration output of the high G-shock accelerometer 10 was measured. Using that change in output an equivalent output is calculated in G's. Another way to look at this is to think in terms of equivalent G's/microstrain. In this case, 1/250 means this 20,000 g full scale range accelerometer has a case sensitivity of 0.004 G/microstain. If an installation applied 1000 microstrain to the bottom of the LCC case 12, an output is measured that is equivalent to 4 G. This is a very small error, 4 parts out of 20,000. If a 20,000 G high G-shock accelerometer 10 is used to measure 1200 G, then the case strain becomes a much larger error, 4 parts out of 1200. This error only exists if there is a 1000 microstrain applied to the LCC case 12. If the LCC case 12 is not stressed, there is no error in the acceleration measurement due to case strain.

In one embodiment, an elastomer is placed in an adjacent relationship between an interior of the LCC case 12 and the MEMs acceleration sensor. In one embodiment, a majority of the MEMs acceleration sensor is encapsulated with an elastomer.

The presence of an elastomer between a bottom of the MEMS acceleration sensor and the bottom which is the base of the LCC case 12, provides very low case strain sensitivity from differential thermal expansion or from structural stresses transmitted into the LCC case 12.

The presence of the elastomer between the bottom, sides, and ends of the MEMS acceleration sensor and the bottom and walls of the LCC case 12 provides adequate tensile and shear strength for the MEMs acceleration sensor 14 to be retained in the LCC case 12 during high G shock loads in all axes. The presence of the elastomer between the bottom of the LCC case 12 and the bottom of the MEMS acceleration sensor provides excellent transmission of both low and high frequency accelerations, as non-limiting examples from 0 to 100,000 Hz, 1 to 100,000 Hz, 10 to 100,000 Hz and the like.

### EXAMPLE 1

In one embodiment, the MEMS sensor is a single axis sensor. In another embodiment the MEMs sensor is a dual or triaxial MEMS sensor that can use the same mounting technique. In one embodiment, a pneumatically propelled projectile was used to generate a known shock. Frequency response was tested out to 50 kHz. Frequency response was measured at 10 g and at numerous frequencies from 20 Hz up to 50,000 Hz and was not effected.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention.

What is claimed is:

1. A high-G shock accelerometer, comprising:
an LCC case;
a MEMs acceleration sensor positioned in an interior of the LCC case, the MEMs acceleration sensor having exterior surfaces including top and bottom surfaces, end and side surfaces;
an elastomer adjacent to a majority of the exterior surfaces and to the interior of the LCC case; and
wherein the elastomer provides for a reduction in LCC case strain sensitivity to low levels while maintaining high frequency response.

2. The high-G shock accelerometer of claim 1, wherein the elastomer between the MEMs acceleration sensor and the LCC case has negligible effect on phase and amplitude frequency response.

3. The high-G shock accelerometer of claim 1, wherein the MEMs acceleration sensor in the LCC case has low case strain sensitivity to low levels of strain while maintaining good high frequency response.

4. The high-G shock accelerometer of claim 1, wherein the MEMs acceleration sensor includes a base, a core, a side, a seismic mass positioned in the core, a plurality of piezoresistive strain gages, electrical traces and bonding pads.

5. The high-G shock accelerometer of claim 1, wherein the MEMS acceleration sensor is restrained in the LCC case under high G shocks.

6. The high-G shock accelerometer of claim 1, wherein the MEMS acceleration sensor is restrained in the LCC case under a shock of at least 100 G.

7. The high-G shock accelerometer of claim 1, wherein the MEMS acceleration sensor is restrained in the LCC case under a shock of at least 50,000 G.

8. The high-G shock accelerometer of claim 1, wherein the MEMS acceleration sensor is restrained in the LCC case under a shock of at least 80,000 G.

9. The high-G shock accelerometer of claim 1, wherein the MEMS acceleration sensor is restrained in the LCC case under a shock of at least 300,000 G.

10. The high-G shock accelerometer of claim 1, wherein the elastomer is positioned between at least a majority of a bottom of the LCC case and a bottom of the MEMS acceleration sensor.

11. The high-G shock accelerometer of claim 1, wherein the elastomer provides transmission of both low and high frequency accelerations.

12. The high-G shock accelerometer of claim 11, wherein the elastomer provides transmission of both low and high frequency accelerations of from 0 to 100,000 Hz.

13. The high-G shock accelerometer of claim 11, wherein the elastomer provides transmission of both low and high frequency accelerations of from 1 to 100,000 Hz.

14. The high-G shock accelerometer of claim 11, wherein the elastomer provides transmission of both low and high frequency accelerations of from 10 to 100,000 Hz.

15. The high-G shock accelerometer of claim 1, wherein the MEMs acceleration sensor with the elastomer attenuates LCC case strain sensitivity to high fidelity.

16. The high-G shock accelerometer of claim 1, wherein the elastomer is adjacent to a majority of the bottom and side surfaces.

17. The high-G shock accelerometer of claim 1, wherein the MEMs acceleration die has one axis.

18. The high-G shock accelerometer of claim 1, wherein the MEMs acceleration die has two or three axes.

19. The high-G shock accelerometer of claim 1, wherein the MEMs acceleration die is a dual-stack or tri-stack.

20. The high-G shock accelerometer of claim 19, wherein the dual or tri-stack includes two or three wafers bonded together that are singulated.

21. The high-G shock accelerometer of claim 1, wherein the lid protects the MEMS die and provides a hermetic enclosure.
